(19) United States
(12) Patent Application Publication
(10) Pub. No.: US 2018/0181277 A1
(43) Pub. Date: Jun. 28, 2018

(54) PANEL DRIVING INTEGRATED CIRCUIT

(71) Applicant: SILICON WORKS CO., LTD., Daejeon (KR)

(72) Inventor: Yong Sung AHN, Seoul (KR)

(21) Appl. No.: 15/853,268

(22) Filed: Dec. 22, 2017

(30) Foreign Application Priority Data
Dec. 26, 2016 (KR) 10-2016-0178819

(51) Int. Cl. G06F 3/0488; G06F 3/041; G02F 1/1333; G06F 3/0481

(52) U.S. Cl. CPC G06F 3/0488; G06F 3/0412; G06F 3/0481; G02F 1/13338; G06F 3/0416

(57) ABSTRACT

Disclosed is a panel driving integrated circuit into which a data driving circuit and a touch driving circuit are integrated, wherein the data driving circuit and the touch driving circuit share some elements thereof, whereby the number of components and the area of the panel driving integrated circuit can be reduced.

### CROSS REFERENCE TO RELATED APPLICATION

This application claims priority from Republic of Korea Patent Application No. 10-2016-0178819, filed on Dec. 26, 2016, which is hereby incorporated by reference for all purposes as if fully set forth herein.

### BACKGROUND OF THE INVENTION

### 1. Field of the invention

The present invention relates to technology for driving a panel.

### 2. Description of the Prior Art

A display device may include a panel, in which multiple pixels are defined, and circuits that drive the panel.

A panel driving circuit may include, for example, a gate driving circuit that supplies a scan signal to gate lines connected to pixels. Also, the panel driving circuit may include, for example, a data driving circuit that supplies a data voltage to data lines connected to pixels. Also, the panel driving circuit may include, for example, a common voltage electrode (CE) driving circuit that supplies a common voltage to a common voltage electrode (CE) disposed in the panel. Further, the panel driving circuit may include, for example, a touch driving circuit that supplies a touch driving signal to a touch electrode disposed in the panel.

The panel driving circuit may be implemented in the form of an integrated circuit (IC). For example, the gate driving circuit may be implemented as a gate driver IC, and the data driving circuit may be implemented as a data driver IC. Also, for example, the touch driving circuit may be implemented as a touch driver IC.

The respective circuits, for example, the gate driving circuit, the data driving circuit, and the touch driving circuit, may be implemented by ICs separate from each other, but may be integrated into one unit so as to be implemented by one IC. For example, the data driving circuit and the touch driving circuit may be combined and implemented in the form of an integral IC. An integral IC known as a “source readout integrated circuit (SRIC)” is an IC having a form in which parts of the data driving circuit and touch driving circuit are combined.

An integral IC allows multiple circuits to be included within one package, so as to ease the production of the entire system, that is, a display device, and reduce the unit cost of production. However, a conventional integral IC, for example, an SRIC, allows the respective circuits to be combined in a simple manner, and thus, synergy other than the above-described advantages is not derived. As a specific example, the conventional SRIC is implemented such that partial areas are divided from an area within a package, and such that a data driving circuit is disposed in one partial area and a touch driving circuit is disposed in the other partial area. In this structure, it is difficult to derive synergy other than the above-described advantages.

### SUMMARY OF THE INVENTION

In this background, an aspect of the present invention is to provide technology for arranging a data driving circuit and a touch driving circuit so as to increase an integral effect of an IC. Another aspect of the present invention is to provide technology for sharing some elements of a data driving circuit and a touch driving circuit that are implemented by an integral IC.

In accordance with an aspect of the present invention, there is provided a panel driving integrated circuit. The panel driving integrated circuit includes: multiple data voltage output pads that are connected to data voltage signal lines and that output data voltages for controlling greyscales of pixels through the data voltage signal lines; and multiple touch driving signal output pads that are connected to touch driving signal lines and that output touch driving signals for touch sensing through the touch driving signal lines, wherein at least one of the touch driving signal lines and at least one of the data voltage signal lines are alternately arranged, and a data voltage output pad group including at least one of the data voltage output pads and a touch driving signal output pad group including at least one of the touch driving signal output pads are alternately arranged in a first direction.

In accordance with another aspect of the present invention, there is provided a panel driving integrated circuit. The panel driving integrated circuit includes: multiple data voltage channel circuits that, during a display period, output data voltages for controlling greyscales of pixels through output buffers; and multiple touch channel circuits that, during a touch driving period, output touch driving signals for touch sensing, receive response signals formed in a panel in response to the touch driving signals, and process the response signals through integrators, wherein at least one of the output buffers and at least one of the integrators share an amplifier.

As described above, according to embodiments of the present invention, wiring can be simplified as a result of the arrangement of a data driving circuit and a touch driving circuit in an integral IC. Also, according to embodiments of the present invention, some elements of the data driving circuit and touch driving circuit are shared in the integral IC, so that the number of components and the size of the integral IC can be reduced.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration of a display device according to an embodiment of the present invention;

FIG. 2 is a block diagram illustrating signals supplied to a pixel according to an embodiment of the present invention;

FIG. 3 is a view illustrating an example of an arrangement of pads exposed outside a package of a panel driving IC, and lines that connect the respective pads to a panel;

FIG. 4 is a view illustrating another example of an arrangement of pads exposed outside a package of a panel driving IC;

FIG. 5 is a block diagram illustrating channel circuits included within a package of a panel driving IC; and

FIG. 6 is a block diagram illustrating an internal configuration of a panel driving IC that shares an amplifier.

### DETAILED DESCRIPTION OF THE EXEMPLARY EMBODIMENTS

Hereinafter, exemplary embodiments of the present invention will be described in detail with reference to the accompanying drawings. It should be noted that in assigning reference numerals to elements in the drawings, the same reference numerals will designate the same elements where possible although they are shown in different drawings. Also, in the following description of embodiments of the present invention, a detailed description of known functions and configurations incorporated herein will be omitted when it may make the subject matter of the present invention rather unclear.

In addition, such terms as first, second, A, B, (a), (b), and the like, may be used herein when describing elements of the present invention. These terms are merely used to distinguish one element from other elements, and a property, an order, a sequence, and the like of a corresponding element are not limited by the term. It will be understood that when an element is described as being “connected”, “linked”, or “coupled” to another element, the element may be directly connected or coupled to the another element but may be indirectly “connected”, “coupled”, or “linked” to the another element through a third element.

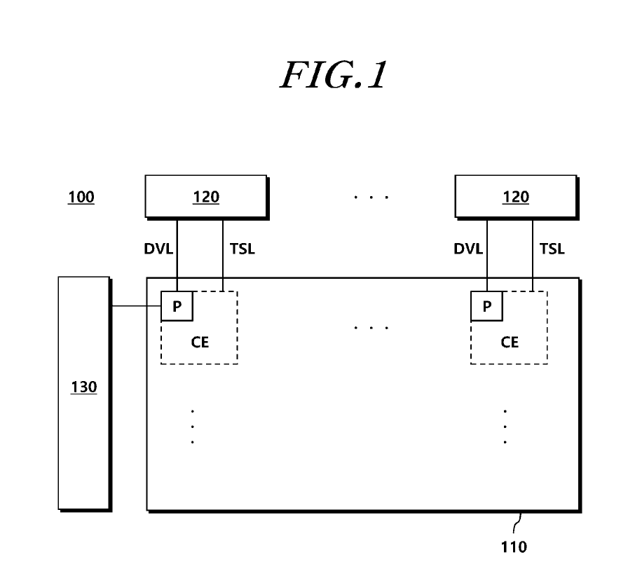

FIG. 1 is a block diagram illustrating a configuration of a display device according to an embodiment of the present invention.

Referring to FIG. 1, the display device 100 may include a panel 110, a panel driving IC 120, a gate driving circuit 130, and the like.

The panel 110 may include only a display panel, and may further include a touch screen panel (TSP). Here, the display panel and the TSP may share some elements thereof with each other. For example, a touch electrode for detecting a touch in the TSP may be a CE to which a common voltage is supplied in the display panel. From the perspective that the display panel and the TSP share some elements thereof with each other, the panel 110 is referred to as “integrated panel”, but the present invention is not limited thereto. Also, as a form in which the display panel and the TSP share some elements thereof with each other, an in-cell-type panel is known, but is only an example of the above-described panel 110. Therefore, a panel to which the present invention is applied is not limited to the in-cell-type panel.

The panel driving IC 120 may include a data driving circuit and a touch driving circuit

In order to display a digital image at pixels P of the panel 110, the data driving circuit supplies a data voltage to data lines. The data driving circuit may receive image data from a timing controller and the like, may convert the image data into a data voltage, and then may supply the data voltage to data lines. The data driving circuit may supply a data voltage to a data line through a Data Voltage Line (DVL).

The touch driving circuit may supply a touch driving signal to a touch electrode disposed in the panel 110, may receive a response signal responding to the touch driving signal, and may sense a touch or proximity of an external object to the panel 110. A CE disposed in the panel 110 may serve as a touch electrode. In the present embodiment, the touch driving circuit may supply a touch driving signal to a CE, may receive a response signal formed at the CE, and may sense a touch or proximity of an external object to the panel 110. The touch driving circuit may supply a touch driving signal to a touch electrode through a touch driving signal line (Touch Signal Line (TSL)).

The display device 100 may include one panel driving IC 120, but when the number of pixels P or CEs is large, may include multiple panel driving ICs 120.

In order to turn on or off transistors located at the respective pixels P, the gate driving circuit 130 may sequentially supply a scan signal to gate lines (GLs).

According to a driving scheme, the gate driving circuit 130 may be disposed at only one side of the panel 110 as illustrated in FIG. 1, or may be divided into two parts and may be disposed at both sides of the panel 110.

Also, the gate driving circuit 130 may be implemented by at least one gate driver IC, and the at least one gate driver IC may be connected to a bonding pad of the panel 110 according to a tape automated bonding (TAB) scheme or a chip on glass (COG) scheme, or may be implemented in a gate in panel (GIP) type and may be directly formed in the panel 110. According to circumstances, the gate driving circuit 130 may be integrated into and formed in the panel 110. Alternatively, the gate driving circuit 130 may be implemented according to a chip on film (COF) scheme.

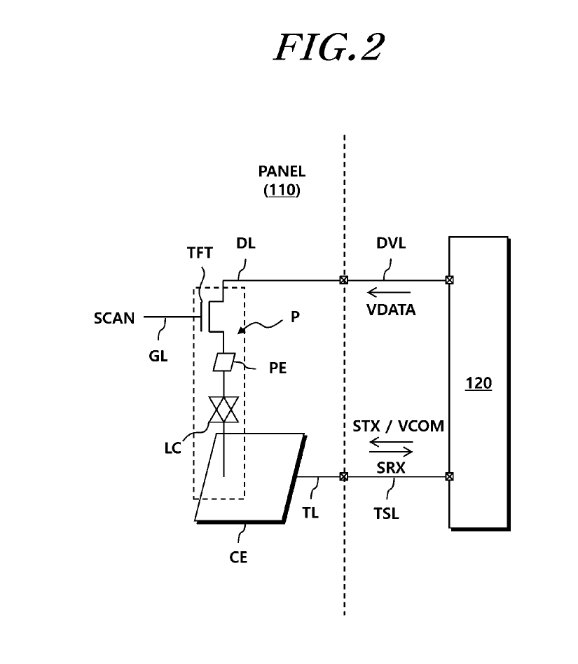

FIG. 2 is a block diagram illustrating signals supplied to a pixel according to an embodiment of the present invention.

Referring to FIG. 2, a pixel P may include a transistor (thin-film transistor (TFT)), a pixel electrode (PE), a liquid crystal (LC), and a CE.

A gate terminal of the transistor TFT may be connected to a GL, a drain terminal thereof maybe connected to a DL, and a source terminal thereof may be connected to the PE in the direction of the LC.

When a scan signal SCAN corresponding to a turn-on voltage is supplied to the gate terminal through the GL, the drain and source terminals of the transistor TFT may be conducted, and a data voltage VDATA may be supplied in the direction of the LC through the PE. At this time, the panel driving IC 120 may supply the data voltage VDATA to the DL through a data voltage transmission line DVL. The data voltage transmission line DVL is a transmission line that electrically connects the DL to the panel driving IC 120.

The CE may be supplied with a common voltage VCOM or a touch driving signal STX.

The panel driving IC 120 may supply a common voltage VCOM to the CE during a display period, and may output a touch driving signal STX to the CE during a touch driving period.

In the panel 110, a touch line (TL) connected to the CE may be disposed, and a touch driving signal line TSL may electrically connect the TL to the CE.

The greyscale of the pixel P may be determined by the difference between a data voltage VDATA supplied to the PE and a common voltage VCOM supplied to the CE during a display period. Typically, a common voltage VCOM may be supplied to all of the pixels at the same voltage level, and the greyscale of the pixel P may be determined according to the adjustment of a data voltage VDATA.

The CE is used as a touch electrode during a touch driving period, and the panel driving IC 120 checks a value corresponding to the capacitance or a variation of the capacitance of the CE, thereby sensing a touch or proximity of an external object to the panel 110. As a specific example, the panel driving IC 120 may supply a touch driving signal STX to the CE, and may receive a response signal SRX formed at the CE by the touch driving signal STX. Then, the panel driving IC 120 may sense a touch or proximity of an external object to the panel 110 by using the response signal SRX.

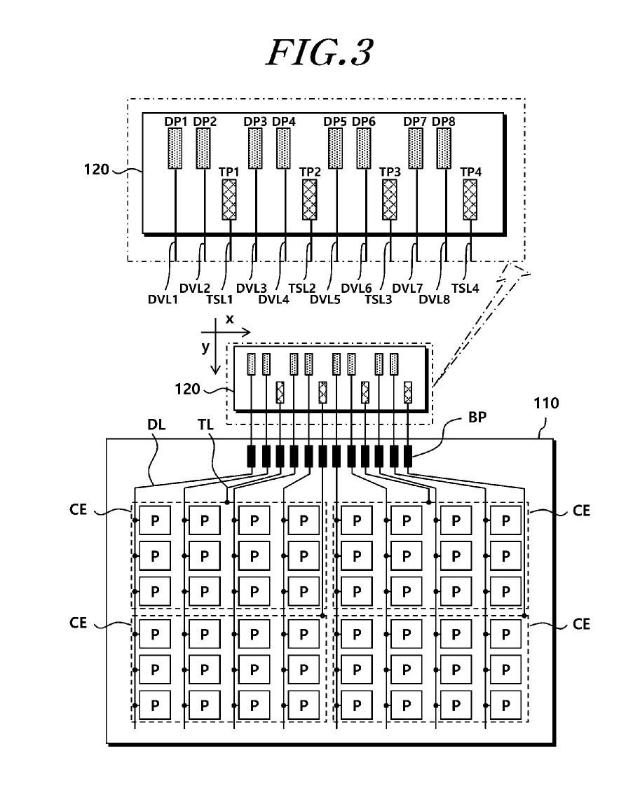

FIG. 3 is a view illustrating an example of an arrangement of pads exposed outside a package of a panel driving IC, and lines that connect the respective pads to a panel.

Referring to FIG. 3, the panel driving IC 120 may be connected to data voltage signal lines DVL1 to DVL8, and may include multiple data voltage output pads DP1 to DP8 that output data voltages for controlling greyscales of pixels P through the data voltage signal lines DVL1 to DVL8. Also, the panel driving IC 120 may be connected to touch driving signal lines TSL1 to TSL4, and may include multiple touch driving signal output pads TP1 to TP4 that output touch driving signals for touch sensing through the touch driving signal lines TSL1 to TSL4.

The pads DP1 to DP8 and TP1 to TP4 exposed outside the package of the panel driving IC 120 may be electrically connected to bonding pads (BPs) arranged in the panel 110. Here, the pads DP1 to DP8 and TP1 to TP4 of the panel driving IC 120 may be connected to the BPs of the panel 110 through the data voltage signal lines DVL1 to DVL8 and the touch driving signal lines TSL1 to TSL4.

Meanwhile, according to the arrangement of the data voltage output pads DP1 to DP8 and the touch driving signal output pads TP1 to TP4 in the panel driving IC 120, the data voltage signal lines DVL1 to DVL8 and the touch driving signal lines TSL1 to TSL4 are arranged without intersecting with each other. Also, DLs connected to the data voltage signal lines DVL1 to DVL8 and TLs connected to the touch driving signal lines TSL1 to TSL4 are arranged without intersecting with each other.

Since a pixel P and a CE are arranged to overlap with each other on a plane, only when a TL is disposed between DLs, a DL and a TL can be arranged without intersecting with each other. Otherwise, a DL and a TL intersect with each other on a plane, and in order to prevent the intersection between the lines, the DL and the TL need to be arranged in different layers, which result in design constraints.

In the display device 100 according to an embodiment of the present invention, the touch driving signal lines TSL1 to TSL4 do not intersect with the data voltage signal lines DVL1 to DVL8 and may be arranged between two or more data voltage signal lines DVL1 to DVL8. Accordingly, the TLs do not intersect with the DLs and may be arranged between two or more DLs. Also, in the panel 110 according to an embodiment of the present invention, DLs and TLs may be arranged on the same layer.

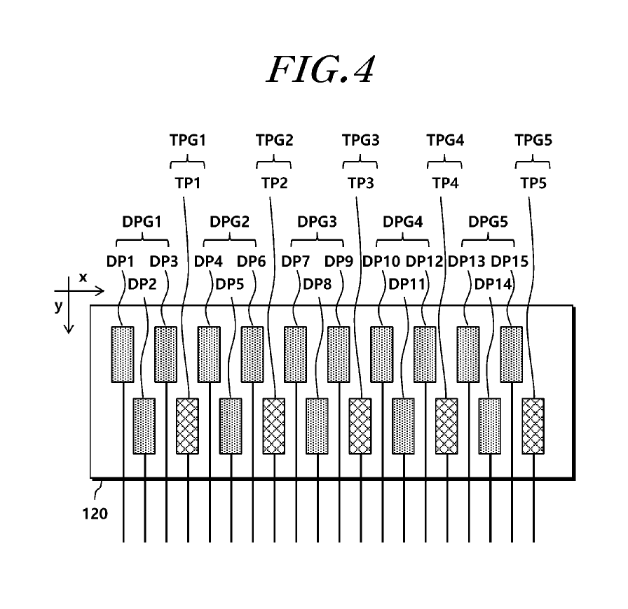

FIG. 4 is a view illustrating another example of an arrangement of pads exposed outside a package of a panel driving IC.

Referring to FIG. 4, the panel driving IC 120 may include multiple data voltage output pads DP1 to DP15 and multiple touch driving signal output pads TP1 to TP5. Also, at least one of the data voltage output pads DP1 to DP15 may be grouped on a per-at least one data voltage output pad basis so as to create multiple data voltage output pad groups DPG1 to DPG5, and at least one of the touch driving signal output pads TP1 to TP5 may be grouped on a per-at least one touch driving signal output pad basis so as to create multiple touch driving signal output pad groups TPG1 to TPG5.

Outside the package of the panel driving IC 120, the data voltage output pad groups DPG1 to DPG5 and the touch driving signal output pad groups TPG1 to TPG5 may be alternately arranged in a first direction (e.g., the x direction). For example, the first data voltage output pad group DPG1 may be disposed, the first touch driving signal output pad group TPG1 may be disposed beside the first data voltage output pad group DPG1, and the second data voltage output pad group DPG2 may be disposed beside the first touch driving signal output pad group TPG1.

The data voltage output pads DP1 to DP15 and the touch driving signal output pads TP1 to TP5 may form different rows as illustrated in FIG. 3. Alternatively, as illustrated in FIG. 4, the data voltage output pads DP1 to DP15 may form multiple rows, the touch driving signal output pads TP1 to TP5 may form a single row, and some of the data voltage output pads DP1 to DP15 may form the same row as that formed by the touch driving signal output pads TP1 to TP5.

According to the ratio of the number of DLs to that of CEs, the ratio of the number of the data voltage output pads DP1 to DP15 to that of the touch driving signal output pads TP1 to TP5 may be determined. Typically, since the number of DLs is larger than that of CEs, the data voltage output pads DP1 to DP15 may form multiple rows, and the touch driving signal output pads TP1 to TP5 may form rows the number of which is smaller than that of the rows formed by the data voltage output pads DP1 to DP15, or may form a single row.

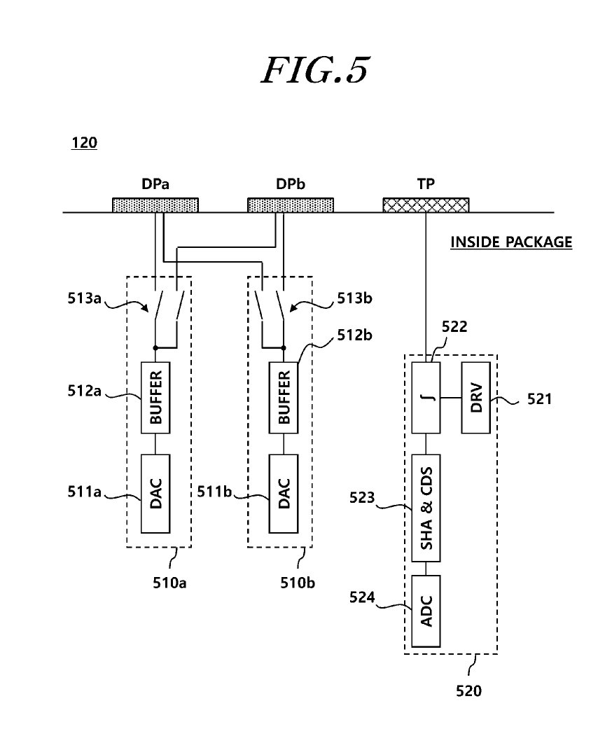

FIG. 5 is a block diagram illustrating channel circuits included within a package of a panel driving IC.

Referring to FIG. 5, the panel driving IC 120 may include multiple data voltage channel circuits 510a and 510b, wherein each of the multiple data voltage channel circuits 510a and 510b generates data voltages and supplies the generated data voltages to data voltage output pads DPa and DPb. Also, the panel driving IC 120 may include multiple touch channel circuits 520 each of which receives a response signal, which is formed in the panel in response to a touch driving signal, through a touch driving signal output pad TP and processes the received response signal.

The data voltage channel circuit 510a and 510b may include digital-to-analog converters 511a and 511b each of which converts a digital signal according to image data into a data voltage which is an analog signal. Also, the data voltage channel circuit 510a and 510b may include output buffers 512a and 512b each of which buffers a data voltage output from the digital-to-analog converter 511a or 511b. Also, the data voltage channel circuit 510a and 510b may include switch units 513a and 513b each of which selectively outputs a data voltage output from the output buffer 512a or 512b to the data voltage output pads DPa and DPb. Each of the digital-to-analog converters 511a and 511b may include a gamma circuit having a polarity, and in order to output data voltages having different polarities to the DLs, each of the switch units 513a and 513b may include two switches that are connected to the different data voltage output pads DPa and DPb.

The touch channel circuit 520 may include a touch driving unit 521 that supplies a touch driving signal to the touch driving signal output pad TP. Also, the touch channel circuit 520 may include an integrator 522 that receives and integrates a response signal, which is formed in the panel in response to a touch driving signal, through the touch driving signal output pad TP. Also, the touch channel circuit 520 may include a signal processing circuit 523 that processes (correlated double sampling (CDS) processing and/or sample-and-hold amplifying (SHA) processing) a signal which is output from the integrator 522. Further, the touch channel circuit 520 may include an analog-to-digital converter 524 that converts a signal, which is output from the signal processing circuit 523, into digital data.

Meanwhile, the data voltage channel circuit 510a and 510b and the touch channel circuit 520, which are located adjacent to each other, may share some elements thereof. Through this configuration, the panel driving IC 120 can reduce the number of components and the area thereof.

For example, the data voltage channel circuit 510a and 510b and the touch channel circuit 520 may share amplifier(s). The data voltage channel circuit 510a and 510b and the touch channel circuit 520 may include amplifier(s), wherein the data voltage channel circuit 510a and 510b may output data voltages by using the amplifiers or the touch channel circuit 520 may process a touch driving signal or a response signal by using the amplifier(s). A time period during which the data voltage channel circuit 510a and 510b uses the amplifiers is different from a time period during which the touch channel circuit 520 uses the amplifier(s). Therefore, the data voltage channel circuit 510a and 510b may share the amplifier(s) with the touch channel circuit 520. As a specific example, during a display period, the data voltage channel circuit 510a and 510b may output data voltages by using the amplifiers, and the amplifier(s) may be used to process a touch driving signal or a response signal during a touch driving period. Here, the display period may not overlap with the touch driving period.

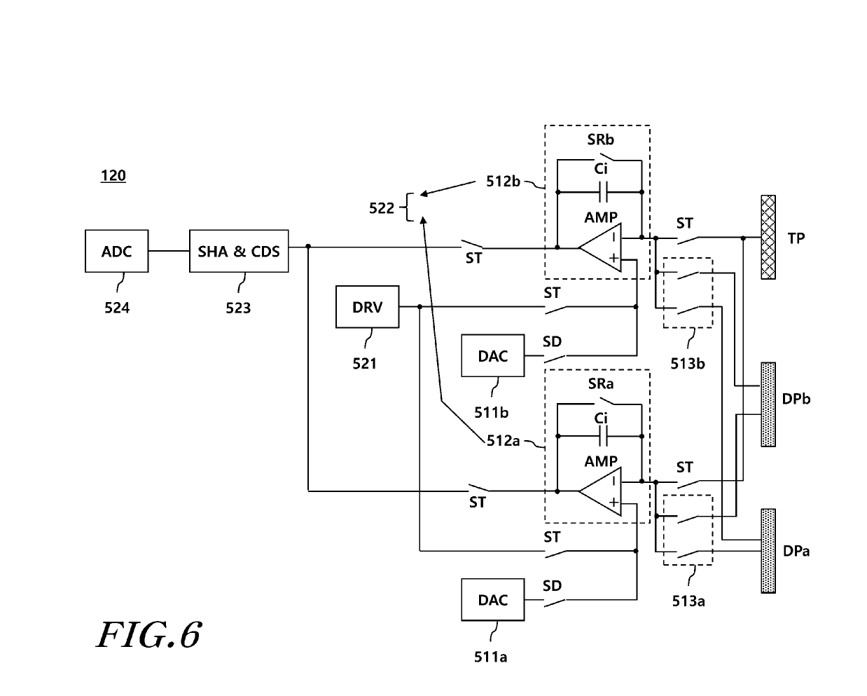

FIG. 6 is a block diagram illustrating an internal configuration of a panel driving IC that shares an amplifier.

Referring to FIG. 6, the output buffers 512a and 512b are used as output buffers for buffering data voltages in the data voltage channel circuit, and may also be used as the integrator 522 for processing a touch driving signal and a response signal in the touch channel circuit.

One output buffer 512a or 512b may be shared as one integrator 522, or two output buffers 512a and 512b may be shared as one integrator 522 as illustrated in FIG. 6. Typically, an amplifier used in an integrator applied to a touch channel circuit requires performance higher than that of an amplifier used in an output buffer applied to a data voltage channel circuit. Therefore, two or more output buffers 512a and 512b may be shared as one integrator 522. However, according to embodiments of the present invention, one output buffer 512a or 512b may be shared as one integrator 522.

The output buffers 512a and 512b or the integrator 522 may include amplifiers AMP, integration capacitors Ci each of which is connected between a first input terminal (e.g., an inverting input terminal) of the amplifier AMP and an output terminal thereof, and reset switches SRa and SRb each of which is connected in parallel to the integration capacitor Ci.

During a display period, when the reset switches SRa and SRb of the output buffers 512a and 512b or the integrator 522 are turned on, the amplifiers AMP and peripheral elements (the reset switches) of the amplifiers AMP serve as buffers. During the display period, the digital-to-analog converters 511a and 511b of the data voltage channel circuit are connected to second input terminals (e.g., non-inverting input terminals) of the amplifiers AMP, and the switches 513a and 513b of the data voltage channel circuit which are connected to the first input terminals of the amplifiers AMP are turned on, thereby allowing data voltages to be output to the data voltage output pads DPa and DPb.

During the display period, display period switches SD, which connect the digital-to-analog converters 511a and 511b to the second input terminals of the amplifiers AMP, are turned on, and touch driving period switches ST of the touch channel circuit are all turned off. The touch driving period switches ST may be arranged between the touch driving unit 521 of the touch channel circuit and the second input terminals of the amplifiers AMP, and may be arranged between the first input terminals of the amplifiers AMP and the touch driving signal output pad TP. Also, the touch driving period switches ST may be arranged between the signal processing circuit 523 and the output terminals of the amplifiers AMP.

During a touch driving period, the display period switches SD are turned off, and the touch driving period switches ST are turned on.

Also, during the touch driving period, a touch driving signal for touch sensing is input to the second input terminal (e.g., the inverting input terminal) of the amplifier AMP, and a response signal, which is formed in the panel in response to the touch driving signal, is integrated by the integrator 522, and the integrated response signal is delivered to the signal processing circuit 523.

As described above, the at least one output buffer 512a and 512b of the data voltage channel circuit may share some elements (e.g., the amplifier(s) AMP) with the at least one integrator 522 of the touch channel circuit. Also, since the performance of the amplifiers AMP required by the output buffers 512a and 512b may be relatively low, an M number of amplifiers AMP used in each of an M (M represents a natural number larger than or equal to 2) number of data voltage channel circuits (e.g., output buffers) during the display period may be used in one touch channel circuit (e.g., an integrator) during the touch driving period. During the touch driving period, each touch channel circuit may process a response signal by using the amplifiers AMP included in at least two data voltage channel circuits.

Meanwhile, the sharing of some elements (e.g., amplifiers) of the data voltage channel circuit and the touch channel circuit, which is allowed therebetween, is related to the adjacent arrangement of the data voltage output pads and the touch driving signal output pads, which are respectively connected to the data voltage channel circuit and the touch channel circuit, on the outer surface the package of the panel driving IC. When data voltage output pads and touch driving signal output pads are arranged in areas separated from each other as in the conventional cases, in terms of the design of an internal circuit, it becomes difficult to share some elements of a data voltage channel circuit and a touch channel circuit therebetween.

As described above, according to the structure in which the data voltage output pads and the touch driving signal output pads are alternately arranged or arranged adjacent to each other, the data voltage signal lines and the touch driving signal lines can be arranged without intersecting with each other, the data lines and the touch lines (common voltage electrode lines) can be arranged without intersecting with each other, and moreover, the data voltage channel circuit and the touch channel circuit can share some elements thereof.

As described above, according to embodiments of the present invention, due to the arrangement of the data driving circuit and the touch driving circuit in the panel driving IC, wiring can be simplified. Also, according to embodiments of the present invention, due to the sharing of some elements of the data driving circuit and the touch driving circuit therebetween in the panel driving IC, the number of components and the size of the panel driving IC can be reduced.

Such terms as “include”, “comprise”, or “have” described hereinabove mean that the relevant elements may exist unless they are specifically described to the contrary, and thus, it should be construed that other elements may be further included rather than being excluded. Unless defined otherwise, all terms including technical and scientific terms have the same meanings as those commonly understood by those having ordinary knowledge in the technical field to which the present invention pertains. Such commonly-used terms as those defined in dictionaries should be interpreted as having meanings identical to contextual meanings of the related art, and will not be interpreted in an idealized or overly formal sense unless expressly so defined in the present invention.

The above description is only an illustrative description of the technical idea of the present invention, and those having ordinary knowledge in the technical field, to which the present invention pertains, will appreciate that various changes and modifications may be made to the embodiments described herein without departing from the essential features of the present invention. Therefore, the embodiments disclosed in the present invention are intended not to limit but to describe the technical idea of the present invention, and thus do not limit the scope of the technical idea of the present invention. The scope of the present invention should be construed based on the appended claims, and all of the technical ideas included within the scope equivalent to the appended claims should be construed as being included within the scope of the present invention.

What is claimed is:

1. An integrated circuit for driving a panel, the integrated circuit comprising:
multiple data voltage output pads that are connected to data voltage signal lines and that output data voltages for controlling greyscales of pixels through the data voltage signal lines; and
multiple touch driving signal output pads that are connected to touch driving signal lines and that output touch driving signals for touch sensing through the touch driving signal lines,
wherein at least one of the touch driving signal lines and at least one of the data voltage signal lines are alternately arranged, and
a data voltage output pad group including at least one of the data voltage output pads and a touch driving signal output pad group including at least one of the touch driving signal output pads are alternately arranged in a first direction.

2. The integrated circuit as claimed in claim 1, wherein the data voltage signal lines are connected to data lines arranged in the panel, the touch driving signal lines are connected to touch lines arranged in the panel, and the data lines and the touch lines are arranged on an identical layer.

3. The integrated circuit as claimed in claim 1, wherein the data voltage output pads and the touch driving signal output pads form different rows.

4. The integrated circuit as claimed in claim 1, wherein the data voltage output pads form multiple rows, and the touch driving signal output pads form a single row.

5. The integrated circuit as claimed in claim 4, wherein some of the data voltage output pads form a row identical to the row formed by the touch driving signal output pads.

6. The integrated circuit as claimed in claim 1, wherein the touch driving signal output pads output the touch driving signals during a touch driving period, and output a common voltage during a display period.

7. The integrated circuit as claimed in claim 1, further comprising:
multiple data voltage channel circuits that generate the data voltages and supply the generated data voltages to the data voltage output pads; and
multiple touch channel circuits that receive response signals, which are formed in the panel in response to the touch driving signals, through the touch driving signal output pads and process the response signals,
wherein at least one of the data voltage channel circuits and at least one of the touch channel circuits share an amplifier.

8. The integrated circuit as claimed in claim 7, wherein, during a touch driving period, each of the touch channel circuits processes the response signal by using the amplifier included in at least two of the data voltage channel circuits.

9. The integrated circuit as claimed in claim 7, wherein the touch channel circuit comprises an integrator comprising the amplifier, and the data voltage channel circuit comprises an output buffer comprising the amplifier.

10. The integrated circuit as claimed in claim 9, wherein the amplifier processes the response signal during a touch driving period, and outputs the data voltage during a display period which does not overlap with the touch driving period.

11. An integrated circuit for driving a panel, the integrated circuit comprising:
multiple data voltage channel circuits that, during a display period, output data voltages for controlling greyscales of pixels through output buffers; and
multiple touch channel circuits that, during a touch driving period, output touch driving signals for touch sensing, receive response signals formed in the panel in response to the touch driving signals, and process the response signals through integrators,
wherein at least one of the output buffers and at least one of the integrators share an amplifier.

12. The integrated circuit as claimed in claim 11, wherein the integrator comprises:
the amplifier;
an integration capacitor that is connected between a first input terminal of the amplifier and an output terminal thereof; and
a reset switch that is connected in parallel to the integration capacitor, and
wherein the integrator, which shares the amplifier, turns on the reset switch during the display period.

13. The integrated circuit as claimed in claim 12, wherein the touch driving signal is input to a second input terminal of the amplifier during the touch driving period.

14. The integrated circuit as claimed in claim 11, wherein data voltage output pads and touch driving signal output pads, which are respectively connected to the data voltage channel circuits and the touch channel circuits that share the amplifiers, are arranged adjacent to each other on an outer surface of a package.

15. The integrated circuit as claimed in claim 11, wherein an M number of the amplifiers used in each of an M number of the output buffers are used in one of the integrators during the touch driving period, wherein M represents a natural number larger than or equal to 2.
